(19) United States
(12) Patent Application Publication
(10) Pub. No.: US 2003/0078977 A1
(43) Pub. Date: Apr. 24, 2003

(54) Dairy message system

(76) Inventor: Robert Coneliano, New South Wales (AU)

Correspondence Address: Edwin D. Schindler, Five Hirsch Avenue, P. O. Box 966, Coram, NY, 11727-0966, US

(21) Appl. No.: 09/893,325

(22) Filed: Jun. 27, 2001

(30) Foreign Application Priority Data
Jun. 29, 2000 (AU) 43745/00
Jun. 15, 2000 (AU) 51956/01

(51) Int. Cl. G06F 1/00; G06F 15/16

(52) U.S. Cl. 709/206; 708/112

(57) ABSTRACT

A computer diary message system, includes data input means for entering data blocks relating to an event in respect of a plurality of predefined data records; means for generating and storing a first representation of each formed data block combined with an original date. The stored data blocks are attached to the predefined data records as a diary record. The diary records associated with each predefined data record are displayed and messages relating to diary records are created and sent to users of the system where they are displayed for the recipient. Predefined data records to which the diary message relate are accessible in order that the message can be acted on.

This invention relates to a diary message system and, in particular, to a system which records events relating to various matters and which facilitate communication between various parties.

### BACKGROUND OF THE INVENTION

In the operation of a business, there is a need to record events relating to various business matters such as customers, suppliers, sales orders, purchases, personnel, etc in order to provide diary reminders for follow up activity. Such diary schedules or reminder systems are often hand written or individually based by each staff member. In such circumstances, there is a lack of communication between various staff members as to what is required to be done and when to do it.

It is therefore advantageous to provide a computerised or electronic diary message system which electronically records events or information regarding the operation of a business such that the information can be sent electronically to various ones of staff members who can use that message to access data previously stored in the computer system according to requirements.

### OBJECT OF THE INVENTION

It is an object of the present invention to provide a diary message system suitable for use in businesses and the like which allows data regarding events or the like to be entered into the diary such that the diary entry can be sent electronically to various users of the system for access thereto and to provide user access to other data already entered in the system. At the very least, it is an object to provide an alternative to known systems.

### DISCLOSURE OF THE INVENTION

According to the present invention, there is provided a computer diary message system, including data input means for entering data blocks relating to an event in respect of a plurality of predefined data records;

means for generating and storing a first representation of each formed data block combined with an original date, said stored data blocks being defined as a diary record;

means for displaying said diary records associated with each predefined data record;

means for creating and sending messages to users of the system relating to diary records;

means for displaying received messages; and

means for accessing said predefined data records to which said diary message relates,

wherein said means for storing said diary records does so in a single diary document.

Preferably, the diary records are entered by all users of the system and identification or id of the user entering the record is included in each particular diary record.

Furthermore, the message preferably includes date, user id of user who entered the diary record, and name and/or reference number of the predefined data record to which it refers.

Preferably, the diary records associated with each data records are displayed in date order, with the most recent diary records being displayed with the option to scroll to display less recent diary records.

Preferably, the means for accessing the predefined data records to which the diary message relates includes means to return the user to the received message for action, ie options to archive, delete or continue to the next message.

### BRIEF DESCRIPTION OF THE DRAWINGS

An embodiment of the present invention will now be described with reference to the drawings in which:

FIG. 1 is a schematic flow diagram of a computer diary message system of the present invention.

### BEST MODE OF CARRYING OUT THE INVENTION

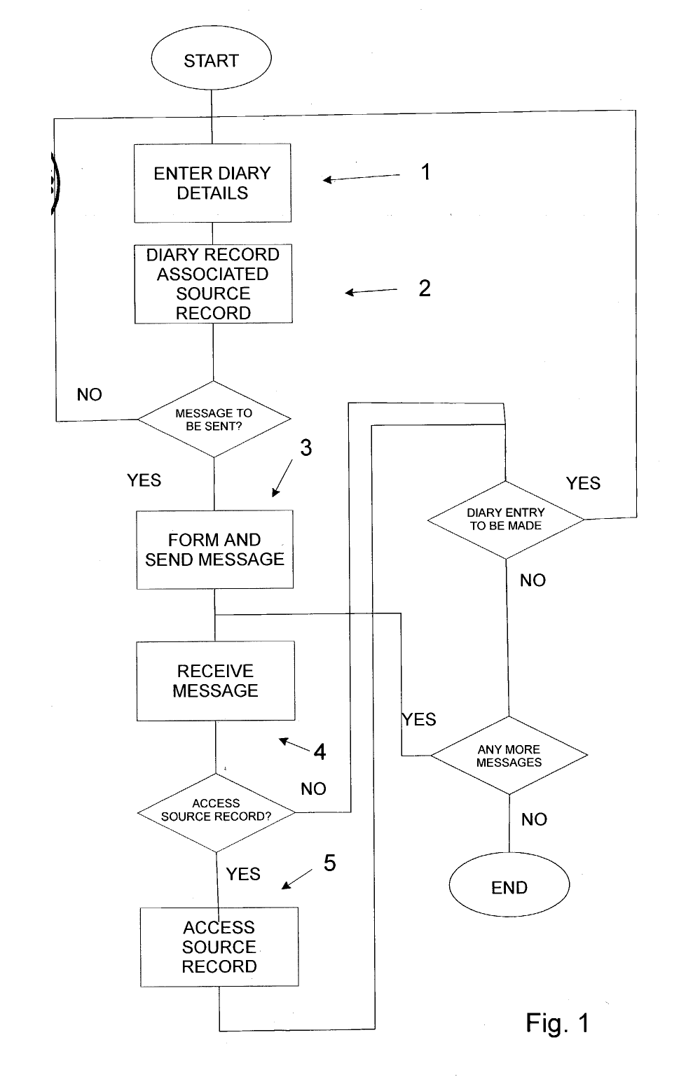

The diary-message system of the preferred embodiment of the present invention is used to record events in the diary relating to various business matters as well as facilitating internal messages or correspondence to be able to be sent between the users of the system is seen in the flow chart of FIG. 1.

The diary-message system is used on a computer network with a number of interface devices which are used to input and display computer records. Preferably, the interface devices include a keyboard, mouse and display screen.

The computer network preferably has a number of data records stored thereon with the data records relating to business matters which can include the following matters: Sales Orders; Purchase Orders; Stock Transfers; Sales leads; Fixed Assets; Stock Conversions; Personnel; Customers; Suppliers; Quotations; Procedures; Competitors; Offers; Contracts; etc. Naturally any matters which relate to any part of the business can be formed into data records to be used with the system of the present invention. These data records are the basis of the business' operation and can be referred to as source records.

In accordance with the preferred embodiment, a diary record is entered via the interface devices and are stored in a central diary file and are attached to each of the source records, the diary records detailing past events, pieces of information, and correspondence relating to the particular source record. Each diary record (step 1 ) includes the following fields, each field being preferably displayed in columns as seen below:

| | |
|---|---|
| DATE | Date information is entered |
| ID | The identification or ID of the user entering the information |
| DETAILS | The information which has been entered. |

In the preferred embodiment, the system automatically enters the date and the ID of the user entering the diary record, thereby only the details need be entered by the user. Naturally these details can be entered manually if desired.

Once a diary entry has been recorded (step 2), it is preferably included in the diary record in chronological order such that the latest entries are displayed on the screen with an ability to scroll through and search for particular diary entries.

Once the diary entry has been made in the central diary record, the user making the entry can create and send a message to other users of the system (step 3). This message can include that particular diary entry or can include one or more of the diary entries made that particular day. Or alternatively, can include diary entries made in previously. The messages are preferably sent by providing the correct instructions to the system, such as pressing a predefined key on the keyboard or clicking on the mouse.

The electronic message that is created, preferably contains the portion of the diary records that relate to today's date and preferably appears on the screen in a similar manner to the original display arrangement of the diary records. The message preferably includes the Date, ID, and Details as well as the name and/or reference number of the source record to which it relates, eg Sales Order 123456.

When a message is received by another user (step 4), that other user can directly access the source record to which the message and the diary record relates (step 5). The addressee can view any part of the diary or the source records to which it is related to (eg Sales Order 123456) and can enter further information into the diary records, which in turn can be sent as a further message as outlined above.

After dealing with the received message and its related source records, the addressee is preferably automatically returned to the incoming message with the options to archive, delete or continue on to the next message.

The system of the preferred embodiment therefore provides an efficient means of entering and dealing with diary records as well as facilitating internal communication within a business organisation.

In summary the system of the preferred embodiment has the ability to create, add data to and view diary records related to any number of computer records used in business.

The diary entries are either a record of an event, a request for information or a request, suggestion or instruction for certain action, or a response to a request.

The system also has the ability to cause the diary entry to be automatically copied into and sent as an electronic message to any or a number selected users of that computer system.

In addition, the system has the ability whereby the receiver of that electronic message, with very few keystrokes, can choose to view the originating computer record and therefore also the whole of the related diary and if he chooses to, himself add data and send a message or a response to the message.

There are basically three benefits to this system:

The building up of a complete history of all data being records of events and correspondence between computer users without the need to duplicate this data to create messages; and

Whilst viewing incoming electronic messages, giving users the ability to directly access the source record by entering as little as one key stroke, thereby avoiding the need to search for the appropriate menu option and avoiding the search for the appropriate record. This giving the user the ability to respond to the original message or creating and sending a new message;

Once the user has accessed the source record and actioned as necessary, he is automatically returned to the message and provided with the ability to delete and move onto the next one.

In essence the benefits are of reduced typing and keystrokes, thereby increasing efficiency and the building up of very complete history relating to each computer record.

The foregoing describes only some embodiments of the present invention, and modifications obvious to those skilled in the art can be made thereto without departing from the scope of the present invention.

1. A computer diary message system, including data input means for entering data blocks relating to an event in respect of a plurality of predefined data records;
means for generating and storing a first representation of each formed data block combined with an original date, said stored data blocks being defined as a diary record;
means for displaying said diary records associated with each predefined data record;
means for creating and sending messages to users of the system relating to diary records;
means for displaying received messages; and
means for accessing said predefined data records to which said diary message relates,
wherein said means for storing said diary records does so in a single diary document.

2. The computer diary message system according to claim 1, wherein the diary records are entered by all users of the system and identification or id of the user entering the record is included in each particular diary record.

3. The computer diary message system according to claim 2, wherein the message includes date, user id of user who entered the diary record, and name and/or reference number of the predefined data record to which it refers.

4. The computer diary message system according to claim 1, wherein the means for accessing the predefined data records to which the diary message relates includes means to return the user to the received message for action, with options to archive, delete or continue to the next message.

5. The computer diary message system according to claim 1, wherein the diary records associated with each data records are displayed in date order, with the most recent diary records being displayed with the option to scroll to display less recent diary records.
